(19) United States
(12) Patent Application Publication
(10) Pub. No.: US 2024/0078471 A1
(43) Pub. Date: Mar. 7, 2024

(54) METHOD OF INTEGRALLY OPTIMIZING PARAMETERS

(71) Applicant: INDUSTRY ACADEMY COOPERATION FOUNDATION OF SEJONG UNIVERSITY, Seoul (KR)

(72) Inventors: Jae Ho KIM, Seongnam-si (KR); Yu Jin KIM, Seoul (KR); Ju Yeon WEON, Seoul (KR); Se Jung KIM, Seoul (KR); Tae In YONG, Seoul (KR)

(21) Appl. No.: 18/460,636

(22) Filed: Sep. 4, 2023

(30) Foreign Application Priority Data
Sep. 5, 2022 (KR) 10-2022-0111894

(51) Int. Cl. G06N 20/00

(52) U.S. Cl. CPC G06N 20/00

(57) ABSTRACT

Disclosed is a method of integrally optimizing different types of parameters that require setting during a machine learning process. The disclosed method of integrally optimizing the parameters includes performing training on a machine learning model by selecting sensor parameters and machine learning model hyperparameters until a predetermined termination condition is satisfied; and determining, among the selected sensor parameters and machine learning model hyperparameters, an optimized sensor parameter and optimized machine learning model hyperparameter that minimize a loss value for the machine learning model, wherein the performing of the training on the machine learning model includes selecting the sensor parameters and machine learning model hyperparameters that satisfy a predetermined optimization range, and performing training on the machine learning model based on sensor data provided from a sensor by the selected sensor parameters and the machine learning model hyperparameters.

### CROSS-REFERENCE TO RELATED APPLICATIONS

This application claims priority under 35 U.S.C. 119(a) to Korean Patent Application No. 10-2022-0111894 filed on Sep. 5, 2022, in the Korean Intellectual Property Office, all of the contents of the above-listed applications are hereby incorporated by reference.

### TECHNICAL FIELD

The present disclosure relates to a method of optimizing parameters, and more particularly, to a method of integrally optimizing different types of parameters that require setting during a machine learning process.

### BACKGROUND ART

Recently, applications that utilize sensor data for machine learning have been increasing. For example, in autonomous vehicles, machine learning is employed to detect nearby obstacles using sensor data, and in smart factories, machine learning is employed to detect abnormal processes using sensor data.

In such environments where sensor data is utilized for machine learning, when only a hyperparameter of a machine learning model is optimized, there are limitations in enhancing the learning efficiency of the machine learning model, and optimization of a sensor parameter is also required.

In particular, recently, the number of sensors used in machine learning environments has been increasing. In addition, various types of sensors are utilized, such as fusion sensors, virtual sensors, soft sensors, etc., in addition to physical sensors, and optimization of the sensor parameters is inevitably required along with an increase in demand for lower-cost sensors with relatively lower accuracy.

### DISCLOSURE

### Technical Problem

The present disclosure is directed to providing a method of integrally optimizing hyperparameters, sensor parameters, preprocessing filters, and the like of a machine learning model.

### Technical Solution

According to an aspect of the present disclosure, there is provided a method of integrally optimizing parameters, including performing training on a machine learning model by selecting sensor parameters and machine learning model hyperparameters until a predetermined termination condition is satisfied; and determining, among the selected sensor parameters and machine learning model hyperparameters, an optimized sensor parameter and optimized machine learning model hyperparameter that minimize a loss value for the machine learning model, wherein the performing of the training on the machine learning model includes selecting the sensor parameters and machine learning model hyperparameters that satisfy a predetermined optimization range, and performing training on the machine learning model based on sensor data provided from a sensor by the selected sensor parameters and the machine learning model hyperparameters.

According to another aspect of the present disclosure, there is provided a method of integrally optimizing parameters, including performing training on a machine learning model by selecting preprocessing filters and machine learning model hyperparameters until a predetermined termination condition is satisfied; and determining, among the selected preprocessing filters and machine learning model hyperparameters, an optimized preprocessing filter and optimized machine learning model hyperparameter that minimize a loss value for the machine leaning model, wherein the performing of the training on the machine learning model includes selecting the preprocessing filters from a preprocessing filter candidate group and selecting the machine learning model hyperparameters that satisfy a predetermined optimization range, and performing training on the machine learning model based on sensor data provided from a sensor, the preprocessing filters used for preprocessing the sensor data, and the machine learning model hyperparameters.

According to still another aspect of the present disclosure, there is provided a method of integrally optimizing parameters, including performing training on a machine learning model by selecting a weight and machine learning model hyperparameter for each of a plurality pieces of sensor data until a predetermined termination condition is satisfied; and determining, among the selected weights and machine learning model hyperparameters, an optimized weight and optimized machine learning model hyperparameter that minimize a loss value for the machine learning model, wherein the performing of the training on the machine learning model incudes selecting the weights and machine learning model hyperparameters that satisfy a predetermined optimization range; and performing training on the machine learning model based on the sensor data to which the weight is applied and the machine learning model hyperparameters.

### Advantageous Effects

According to an embodiment of the present disclosure, in the process of training the machine learning, the sensor parameters, the hyperparameters, and the preprocessing filters can be integrally optimized, and thus optimization of the sensor parameters and preprocessing filters can be achieved in addition to optimization of hyperparameters that can improve the learning performance of the machine learning model.

### BRIEF DESCRIPTION OF DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a system for integrally optimizing parameters according to an embodiment of the present disclosure;

FIG. 2 is a diagram illustrating a method of integrally optimizing parameters by a system for integrally optimizing parameters;

FIG. 3 is a diagram illustrating a method of integrally optimizing parameters according to an embodiment of the present disclosure;

FIG. 4 is a diagram illustrating a method of integrally optimizing parameters according to another embodiment of the present disclosure; and

FIG. 5 is a diagram illustrating a method of integrally optimizing parameters according to still another embodiment of the present disclosure.

### MODES OF THE INVENTION

Embodiments may have various modifications, and thus specific embodiments are illustrated in the drawings and described in detail in the detailed description. It is to be understood, however, that the disclosure is not to be limited to the specific embodiments, but includes all modifications, equivalents, and alternatives falling within the spirit and scope of the disclosure. Like reference numerals in each figure indicate like components.

A hyperparameter of a machine learning model is a parameter applied to a machine learning model to implement an optimal machine learning model, and examples include epoch, batch size, and learning rate, and various algorithms for optimizing the hyperparameter have been researched. As a method of optimizing a hyperparameter, there are a grid search algorithm, a random search algorithm, Bayesian optimization, and the like.

As described above, in an environment where machine learning is performed using sensor data, there is a limit to enhancing learning performance when only the hyperparameter of the machine learning model is optimized. In order to further enhance the learning performance, optimization of the sensor parameter is required.

In an environment where machine learning is performed using sensor data, since a sensor and a machine learning model are organically combined, it is inefficient to independently optimize the sensor parameter and the hyperparameter of the machine learning model, and thus the present disclosure proposes a method of integrally optimizing a sensor parameter and a hyperparameter of a machine learning model in a process of performing training on the machine learning model.

In a method of integrally optimizing parameters according to an embodiment of the present disclosure, it is possible to integrate and optimize various types of parameters that need to be set in a machine learning process, such as a preprocessing filter for preprocessing sensor data, a weight for the sensor data, and the like, in addition to a sensor parameter and a hyperparameter of a machine learning model.

The method of integrally optimizing parameters according to the embodiment of the present disclosure may be performed by a computing device including a processor and a memory.

Hereinafter, embodiments according to the present disclosure will be described in detail with reference to the accompanying drawings.

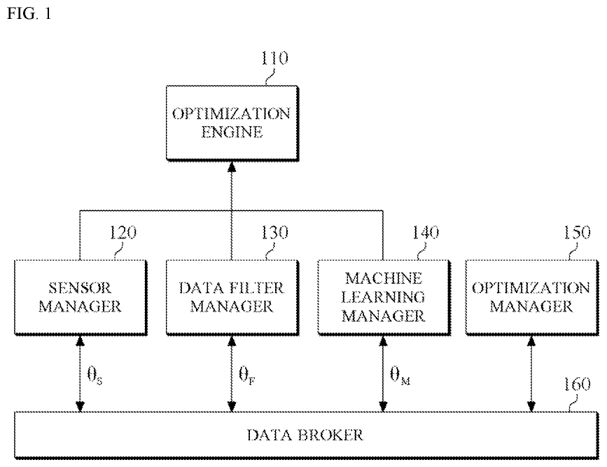

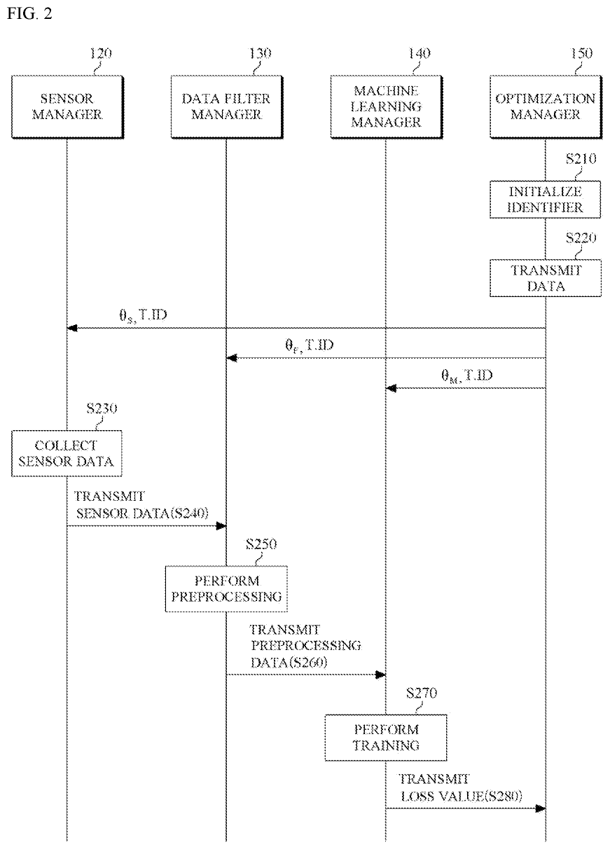

FIG. 1 is a diagram illustrating a system for integrally optimizing parameters according to an embodiment of the present disclosure, and FIG. 2 is a diagram illustrating a method of integrally optimizing parameters by a system for integrally optimizing parameters.

Referring to FIGS. 1 and 2, the system for integrally optimizing parameters according to the embodiment of the present disclosure includes an optimization engine 110, a sensor manager 120, a data filter manager 130, a machine learning manager 140, an optimization manager 150, and a data broker 160.

The optimization engine 110 may determine an optimized sensor parameter, an optimized hyperparameter of the machine learning model, an optimized preprocessing filter, and the like according to a predetermined optimization algorithm. Here, as an embodiment, the machine learning model may be a deep learning model, the hyperparameter may include epoch, batch size, and learning rate, etc., and the preprocessing filter may include an interval average filter, a Gaussian filter, a maximum value filter, a minimum value filter, and the like. The interval average filter is a filter that outputs the average value of data in a predetermined interval, the maximum value filter is a filter that outputs the maximum value of data in a predetermined interval, and the minimum value filter is a filter that outputs the minimum value of data in a predetermined interval. The sensor parameter may include a sampling frequency, sensor sensitivity, and the like, and the sensor parameter may vary depending on the type of a sensor in use. For example, when the sensor in use is a radar sensor, a sensor parameter such as a range interval or a profile for adjusting distance resolution may be optimized.

The optimization manager 150 initializes an identifier T_ID assigned to the sensor parameter, the hyperparameter, and the preprocessing filter in operation S210, and selects a sensor parameter θ_{S}, a hyperparameter θ_{F}, and a preprocessing filter θ_{M} that satisfy a predetermined optimization range to transmit the selected parameters and filter to the sensor manager 120, the data filter manager 130, and the machine learning manager 140 in operation S220. The optimization manager 150 repeatedly selects the sensor parameters, the hyperparameters, and the preprocessing filters until a predetermined termination condition is satisfied, and the identifier T_ID is updated and assigned to the newly selected sensor parameters, hyperparameters, and preprocessing filters.

The termination condition may be, for example, a condition that the number of selections for the sensor parameters, the hyperparameters and the preprocessing filters satisfies a predetermined number of terminations, a condition that a loss value for the machine learning model is less than or equal to a threshold value, a condition that in which a slope value for increasing accuracy is less than or equal to a predetermined slope value, and the like.

When a random search algorithm is used as the optimization algorithm, the optimization manager 150 may randomly select the sensor parameters, the hyperparameters, and the preprocessing filters within a predetermined optimization range. The optimization range can be set by the user.

For example, when the sensor parameter to be optimized is a sampling frequency and the hyperparameter to be optimized is epoch, the optimization range of the sampling frequency may be set as 40 to 60 Hz, candidate groups of the preprocessing filters included in the optimization range may be set as A, B, and C, and the optimization range of epoch values may be set as 200 to 500. In addition, the optimization manager 150 selects 44 Hz as the sampling frequency, A as the preprocessing filter, and 300 as the epoch value, and transmits the selected data to the sensor manager 120, the data filter manager 130, and the machine learning manager 140. Zero may be assigned to the selected data as the identifier T_ID.

The sensor manager 120 applies the sensor parameter provided from the optimization manager 150 to the sensor and collects sensor data using the sensor in operation S230. The sensor generates sensor data according to the sensor parameter provided from the optimization manager 150. Next, the sensor manager 120 transmits the collected sensor data to the data filter manager 130 together with the assigned identifier T_ID=0 in operation S240.

The data filter manager 130 performs preprocessing on the sensor data provided from the sensor manager 120 using the preprocessing filter provided from the optimization manager 150 in operation S250, and transmits the preprocessed sensor data together with the assigned identifier T_ID=0 to the machine learning manager 140 in operation S260.

The machine learning manager 140 performs training on the machine learning model using the sensor data provided from the data filter manager 130 in operation S270, and transmits a loss value for the machine learning model together with the assigned identifier T_ID=0 to the optimization manager 150 in operation S280. The preprocessed sensor data provided from the data filter manager 130 corresponds to training data for training the machine learning model. For example, the machine learning model may be a model that classifies classes of obstacles in front of a vehicle using the sensor data.

When a predetermined termination condition is not satisfied, the optimization manager 150 selects a new sensor parameter, hyperparameter, and preprocessing filter, and transmits the selected data to the sensor manager 120, the data filter manager 130, and the machine learning manager 140. For example, in the optimization range of the above-described example, the optimization manager 150 may newly select 55 Hz as the sampling frequency, B as the preprocessing filter, and 250 as the epoch value, and may transmit the newly selected data to the sensor manager 120, the data filter manager 130, and the machine learning manager 140. In this case, 1 may be assigned to the selected data as the identifier T_ID.

Operations S220 to S280 are repeatedly performed until a predetermined termination condition is satisfied, and the optimization engine 110 may determine the sensor parameter, hyperparameter, and preprocessing filter that minimize a loss value for the machine learning model among the sensor parameters, hyperparameters, and preprocessing filters selected in the iterative process of operations S220 to S280, to be an optimized sensor parameter, optimized hyperparameter, and optimized preprocessing filter.

The data broker 160 is a data channel, and data is transmitted and received among the optimization engine 110, the sensor manager 120, the data filter manager 130, the machine learning manager 140, and the optimization manager 150 through the data broker 160.

As described above, according to the embodiment of the present disclosure, instead of optimizing the sensor parameter, the hyperparameter, and the preprocessing filter through separate optimization processes, the sensor parameter, the hyperparameter, and the preprocessing filter can be integrally optimized in the machine learning process.

Therefore, according to the embodiment of the present disclosure, optimization of sensor parameters and preprocessing filters in addition to optimization of hyperparameters that can improve the learning performance of the machine learning model can be achieved.

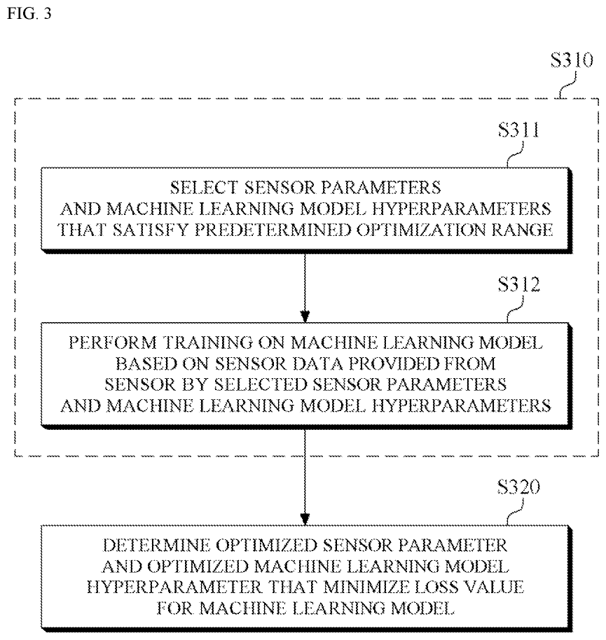

FIG. 3 is a diagram illustrating a method of integrally optimizing parameters according to an embodiment of the present disclosure.

Referring to FIG. 3, in operation S310, a computing device according to an embodiment of the present disclosure selects sensor parameters and machine learning model hyperparameters to perform training on a machine learning model until a predetermined termination condition is satisfied.

In operation S310, the computing device may select sensor parameters and machine learning model hyperparameters that satisfy a predetermined optimization range in operation S311, and perform training on the machine learning model based on sensor data provided from a sensor by the selected sensor parameters and the machine learning model hyperparameters in operation S312.

Next, in operation S320, the computing device determines an optimized sensor parameter and optimized machine learning model hyperparameter that minimize a loss value for the machine learning model among the sensor parameters and machine learning model hyperparameters selected in operation S310. The loss value for the machine learning model may be calculated through a learning process for each of the sensor parameters and machine learning model hyperparameters selected in operation S310. The computing device may determine the sensor parameter and machine learning model hyperparameter obtained when the minimum loss value among the calculated loss values is derived, to be an optimized sensor parameter and optimized machine learning model hyperparameter.

In addition, the computing device may perform training on the machine learning model by selecting preprocessing filters used for preprocessing the sensor data from a predetermined preprocessing filter candidate group until the termination condition is satisfied in operation S310, and determine an optimized preprocessing filter that minimizes the loss value among the selected preprocessing filters in operation S320.

Meanwhile, according to an embodiment, in operation S310, the computing device may select a sensor providing sensor data used for training from a sensor candidate group, and perform training on machine learning by selecting sensor parameters for the selected sensor. That is, the computing device may determine a sensor for optimizing the sensor parameter and optimize the sensor parameter for the determined sensor. In this case, the optimized sensor parameter is an optimized sensor parameter for the sensor selected from the sensor candidate group.

In an environment where many sensors are used, the number of sensor parameters to be optimized may increase, and the parameter optimization time in the entire system may increase exponentially with an increase in the number of sensor parameters to be optimized. Since this optimization time increase problem is solved, according to an embodiment of the present disclosure, it is possible to selectively optimize the sensor parameters for some sensors instead of all sensors used for training. In this case, the sensor to be optimized or the importance of the sensor among the sensors included in the sensor candidate group may be selected by the user.

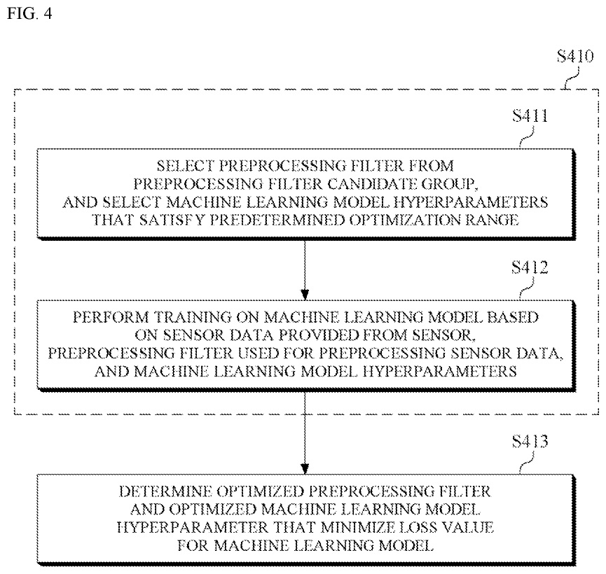

FIG. 4 is a diagram illustrating a method of integrally optimizing parameters according to another embodiment of the present disclosure.

Referring to FIG. 4, in operation S410, a computing device according to an embodiment of the present disclosure performs training on a machine learning model by selecting preprocessing filters and machine learning model hyperparameters until a predetermined termination condition is satisfied. Next, in operation S420, the computing device determines an optimized preprocessing filter and optimized machine learning model hyperparameter that minimize a loss value for the machine learning model among the preprocessing filters and machine learning model hyperparameters selected in operation S410.

In this case, the computing device selects the preprocessing filter from a preprocessing filter candidate group in operation S410, and selects the machine learning model hyperparameter that satisfies a predetermined optimization range in operation S411. Next, in operation S412, the computing device may perform training on the machine learning model based on sensor data provided from a sensor, the preprocessing filter used for preprocessing the sensor data, and the machine learning model hyperparameter. In operation S420, the sensor data preprocessed by the preprocessing filter is used for training the machine learning model.

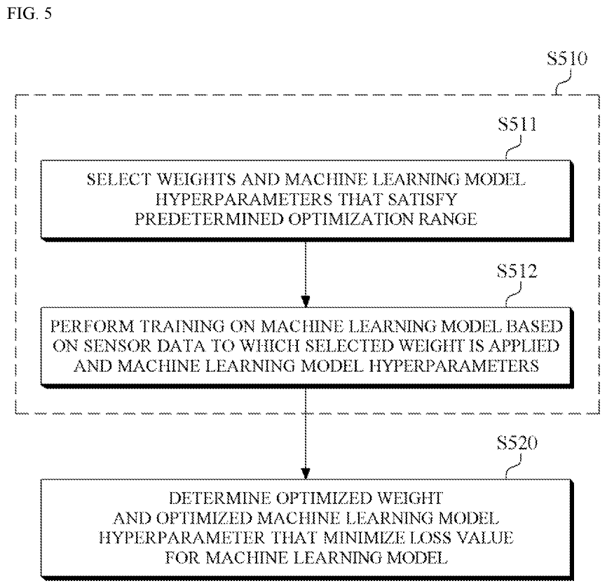

FIG. 5 is a diagram illustrating a method of integrally optimizing parameters according to still another embodiment of the present disclosure.

Referring to FIG. 5, in operation S510, a computing device according to an embodiment of the present disclosure selects a weight and machine learning model hyperparameter for each of a plurality pieces of sensor data, and performs training on the machine learning model until a predetermined termination condition is satisfied.

In operation S510, the computing device selects weights and machine learning model hyperparameters that satisfy a predetermined optimization range in operation S511, and performs training on the machine learning model based on the sensor data to which the weight is applied and the machine learning model hyperparameter in operation S512. In other words, training data used for training the machine learning model, i.e., sensor data, is used for training the machine learning model in the form in which the weight is applied to the sensor data. As an embodiment, the sensor data may be weighted and summed through the weights for the plurality pieces of sensor data, and the weighted and summed data may be used for training the machine learning model. To this end, the computing device may generate training data by applying the weight selected in operation S511 to the sensor data, and perform training on the machine learning model using the training data.

Here, an example of the optimization range for the weight may be in the range of 0 to 1, and the computing device may randomly select a weight for each piece of sensor data. Since the reflection ratio of the sensor data used for training is changed by the weight and sensor data having a weight of 0 is not used for training, it can be said that the sensor data is selectively used for training the machine learning model by the weight.

Next, in operation S520, the computing device determines an optimized weight and optimized machine learning model hyperparameter that minimize a loss value for the machine learning model among the weights and machine learning model hyperparameters selected in operation S510.

Meanwhile, according to an embodiment, in operation S510, the computing device may select a sensor providing sensor data used for training from a sensor candidate group, and select a sensor parameter for the selected sensor to perform training on the machine learning. In this case, the optimized weight is an optimized weight for the sensor data provided by the sensor selected in operation S510.

The above-described technical content may be implemented in the form of program instructions that can be executed through various computer means and may be recorded on a computer-readable medium. The computer-readable medium may include a program command, a data file, a data structure, or the like, or a combination thereof. The program command recorded in the computer-readable medium may be specially designed and configured for an exemplary embodiment of the present disclosure, or may be known and used by a person skilled in the field of computer software. A computer-readable recording medium exemplarily includes magnetic media such as hard disks, floppy disks, and magnetic tapes; optical media such as compact disk-read only memories (CD-ROMs) and digital versatile disks (DVDs); magneto-optical media such as floptical disks; and hardware devices such as a read-only memory (ROM), a random access memory (RAM), and a flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present disclosure, and vice versa.

In the foregoing discussion, although the present disclosure has been described in connection with the specific matters, such as the specific components, the various embodiments, and the drawings, they are provided only for assisting in the understanding of the present disclosure, and the present disclosure is not limited to the embodiments. It will be apparent that those skilled in the art can make various modifications and changes thereto from these descriptions. Therefore, the spirit of the present disclosure should not be limited to the above-described embodiments, and the appended claims and what are modified equally or equivalently thereto will be considered to fall within the scope of the present disclosure.

What is claimed is:

1. A method of integrally optimizing parameters, the method comprising:
performing training on a machine learning model by selecting sensor parameters and machine learning model hyperparameters until a predetermined termination condition is satisfied; and
determining, among the selected sensor parameters and machine learning model hyperparameters, an optimized sensor parameter and optimized machine learning model hyperparameter that minimize a loss value for the machine learning model,
wherein the performing of the training on the machine learning model includes:
selecting the sensor parameters and machine learning model hyperparameters that satisfy a predetermined optimization range; and
performing training on the machine learning model based on sensor data provided from a sensor by the selected sensor parameters and the machine learning model hyperparameters.

2. The method of claim 1, wherein the sensor parameter includes at least one of a sampling frequency, a measurement range, and sensor sensitivity.

3. The method of claim 1, wherein the machine learning model hyperparameter includes at least one of an epoch, a batch size, and a learning rate.

4. The method of claim 1, wherein the performing of the training on the machine learning model includes performing training on the machine learning model by selecting preprocessing filters used for preprocessing the sensor data from a preprocessing filter candidate group until the termination condition is satisfied, and
the determining the optimized sensor parameter and optimized machine learning model hyperparameter includes determining an optimized preprocessing filter that minimize the loss value among the selected preprocessing filters.

5. The method of claim 1, wherein the performing of the training on the machine learning model includes performing training on the machine learning model by selecting a sensor providing sensor data used for training from a sensor candidate group until the termination condition is satisfied, and the optimized sensor parameter is an optimized sensor parameter for the selected sensor.

6. A method of integrally optimizing parameters, the method comprising:
performing training on a machine learning model by selecting preprocessing filters and machine learning model hyperparameters until a predetermined termination condition is satisfied; and
determining, among the selected preprocessing filters and machine learning model hyperparameters, an optimized preprocessing filter and optimized machine learning model hyperparameter that minimize a loss value for the machine leaning model,
wherein the performing of the training on the machine learning model includes:
selecting the preprocessing filters from a preprocessing filter candidate group and selecting the machine learning model hyperparameters that satisfy a predetermined optimization range; and
performing training on the machine learning model based on sensor data provided from a sensor, the preprocessing filters used for preprocessing the sensor data, and the machine learning model hyperparameters.

7. The method of claim 6, wherein the preprocessing filter includes at least one of an interval average filter, a Gaussian filter, a maximum value filter, and a minimum value filter.

8. A method of integrally optimizing parameters, the method comprising:
performing training on a machine learning model by selecting a weight for each of a plurality pieces of sensor data and machine learning model hyperparameter until a predetermined termination condition is satisfied; and
determining, among the selected weights and machine learning model hyperparameters, an optimized weight and optimized machine learning model hyperparameter that minimize a loss value for the machine learning model,
wherein the performing of the training on the machine learning model incudes:
selecting the weights and machine learning model hyperparameters that satisfy a predetermined optimization range; and
performing training on the machine learning model based on the sensor data to which the weight is applied and the machine learning model hyperparameters.

9. The method of claim 8, wherein the performing of the training on the machine learning model includes generating training data by applying the weight to the sensor data, and performing training on the machine learning model using the training data.

10. The method of claim 8, wherein the performing of the training on the machine learning model includes performing training on the machine learning model by selecting a sensor providing sensor data used for training from a sensor candidate group, and
the optimized weight is an optimized weight for the sensor data provided by the selected sensor.
